(19) United States
(12) Patent Application Publication
(10) Pub. No.: US 2018/0304275 A1
(43) Pub. Date: Oct. 25, 2018

(54) SHEET PROCESSING DEVICE, AND SHEET PROCESSING METHOD

(71) Applicant: SEIKO EPSON CORPORATION, Tokyo (JP)

(72) Inventors: Kaneo YODA, Okaya, Nagano (JP); Seiichi TANIGUCHI, Asahi-mura, Nagano (JP)

(21) Appl. No.: 15/767,695

(22) PCT Filed: Oct. 13, 2016
(86) PCT No.: PCT/JP2016/080420

§ 371 Date: Apr. 12, 2018

(30) Foreign Application Priority Data
Oct. 15, 2015 (JP) 2015-203479

(51) Int. Cl. B02C 25/00; B65H 29/60; B02C 18/06; D21H 11/14; D21B 1/10; D21B 1/02

(52) U.S. Cl. CPC B02C 25/00; B65H 29/60; D21B 1/026; D21H 11/14; D21B 1/10; B02C 18/06

(57) ABSTRACT

Provided is a sheet processing device able to suppress consumption of sheets. The sheet processing device has a supply device that supplies sheets; an image acquisition device that acquires an image of a sheet supplied from the supply device; a first decision device that determines whether or not the sheet can be reused based on the image of the sheet acquired by the image acquisition device; and an inverter configured to discharge the sheet without reversing the first side and second side of the sheet when the first decision device determines that the first side of the sheet can be reused, and reverses the first side and second side of the sheet and then discharges the sheet when the first decision device determines that the second side of the sheet can be reused.

### CROSS-REFERENCE TO RELATED APPLICATIONS

This application is a U.S. National stage application of International Patent Application No. PCT/JP2016/0080420, filed on Oct. 13, 2016, which claims priority under 35 U.S.C. § 119(a) to Japanese Patent Application No. 2015-203479, filed in Japan on Oct. 15, 2015. The entire disclosure of Japanese Patent Application No. 2015-203479 is hereby incorporated herein by reference.

### TECHNICAL FIELD

The present invention relates to a sheet processing device, and a sheet processing method.

### BACKGROUND

Document processing devices including a scanner for capturing images of paper documents, and a shredder for shredding the documents, are known from the literature (see, for example, JP-A-2004-228684).

However, because the device described in JP-A-2004-228684 also shreds paper that could be reused, the paper cannot be used effectively and paper consumption cannot be suppressed.

### SUMMARY

The present invention is directed to solving at least part of the foregoing problem, and can be achieved by the embodiments or examples described below.

### Example 1

A sheet processing device according to this example has a supply device that supplies a sheet; an image acquisition device that acquires an image of a sheet supplied from the supply device; a first decision device that determines whether or not the sheet can be reused based on the image of the sheet acquired by the image acquisition device; and an inverter configured to discharge the sheet without reversing the first side and second side of the sheet when the first decision device determines that the first side of the sheet can be reused, and reverses the first side and second side of the sheet and then discharges the sheet when the first decision device determines that the second side of the sheet can be reused.

Thus comprised, an image of a sheet supplied from the supply device is acquired by the image acquisition device, and based on the acquired image of the sheet, whether or not the sheet can be reused is determined. As a result, opportunities to effectively utilize sheet are increased, and consumption of sheets can be suppressed. Furthermore, sheets determined to be reusable are discharged with the surfaces of the sheets that can be reused oriented in the same direction by the inverter. As a result, the sheets can be reused immediately.

### Example 2

The sheet processing device described above, further including: a shredder configured to shred sheets; the shredder shredding the sheet when the first decision device determines both the first side and second side of the sheet cannot be reused.

Thus comprised, because sheets that cannot be reused are shredded by the shredder, leakage of information can be prevented.

### Example 3

The sheet processing device described above, further including: a defibrator configured to defibrate into defibrated material shreds shredded by the shredder; and a sheet forming device configured to form sheets using at least part of the defibrated material.

Thus comprised, shredded sheets can be used as feedstock to produce new sheets.

### Example 4

The first decision device in the sheet processing device described above having a second decision device that determines whether or not there is a problem with the surface condition of the sheet based on an image of the sheet acquired by the image acquisition device; and the shredder shredding the sheet when the second decision device determines there is a problem with the surface condition of the sheet.

Thus comprised, instead of being limited to the recorded state of the sheet, sheets determined to have a reusable side can be reliably identified as sheets unsuited to reuse and removed if there is a problem with the surface condition of the sheet.

### Example 5

The sheet processing device described above, also having an eraser device disposed between the supply device and the image acquisition device in the conveyance direction of the sheet, and configured to erase an image recorded on the sheet.

Thus comprised, consumption of sheets can be further suppressed if a sheet can be reused by erasing the images on the sheet.

### Example 6

Another aspect of the invention is a sheet processing method including: supplying a sheet; acquiring an image of a supplied sheet; determining whether or not the sheet can be reused based on the acquired image of the sheet; and discharging the sheet without reversing the first side and second side of the sheet when the first side of the sheet is determined to be reusable, and reversing the first side and second side of the sheet and then discharging the sheet when the second side of the sheet is determined to be reusable.

Thus comprised, an image of a supplied sheet is acquired, and based on the acquired image of the sheet, whether or not the sheet can be reused is determined. As a result, opportunities to effectively utilize sheet are increased, and consumption of sheets can be suppressed. Furthermore, sheets determined to be reusable are discharged with the surfaces of the sheets that can be reused oriented in the same direction by inversion. As a result, the sheets can be reused immediately.

### BRIEF DESCRIPTION OF THE DRAWINGS

FIG. 1 schematically illustrates the configuration of a sheet processing device according to a first embodiment of the invention.

FIG. 2 is a control block diagram illustrating the control configuration of the sheet processing device according to the first embodiment of the invention.

FIG. 3 is a flow chart describing the sheet processing method according to the first embodiment of the invention.

FIG. 4 shows an example of a display on the touch panel according to the first embodiment of the invention.

FIG. 5 shows an example of a display on the touch panel according to the first embodiment of the invention.

FIG. 6 shows an example of the conditions of the image determination area according to the first embodiment of the invention.

FIG. 7 schematically illustrates operation of the sheet processing device according to the first embodiment of the invention.

FIG. 8 schematically illustrates operation of the sheet processing device according to the first embodiment of the invention.

FIG. 9 schematically illustrates operation of the sheet processing device according to the first embodiment of the invention.

FIG. 10 schematically illustrates operation of the sheet processing device according to the first embodiment of the invention.

FIG. 11 is a flow chart describing another sheet processing method according to the first embodiment of the invention.

FIG. 12 schematically illustrates the configuration of a sheet processing device according to a second embodiment of the invention.

FIG. 13 is a control block diagram illustrating the control configuration of the sheet processing device according to the second embodiment of the invention.

FIG. 14 is a flow chart describing the sheet processing method according to the second embodiment of the invention.

FIG. 15 is a flow chart describing another sheet processing method according to the second embodiment of the invention.

FIG. 16 schematically illustrates the configuration of a sheet processing device according to a third embodiment of the invention.

FIG. 17 schematically illustrates the configuration of a sheet processing device according to a first variation of the invention.

FIG. 18 schematically illustrates the configuration of a sheet processing device according to a second variation of the invention.

### DESCRIPTION OF EMBODIMENTS

First to third embodiments of the invention are described below with reference to the accompanying figures. Note that parts are shown in the accompanying figures in sizes enabling easy recognition thereof, and differ from the actual scale of the actual parts.

### Embodiment 1

The configuration of a sheet processing device is described first. A sheet processing device according to this embodiment has a supply device for supplying sheets; an image acquisition device for acquiring an image of a sheet supplied from the supply device; a first decision device for determining whether or not the sheet can be reused based on the image of the sheet acquired by the image acquisition device; and an inverter configured to discharge without reversing the first side and second side of the sheet when the first decision device determines that the first side of the sheet can be reused, and reverses the first side and second side of the sheet and then discharges the sheet when the first decision device determines that the second side of the sheet can be reused. The sheet processing device is described more specifically below.

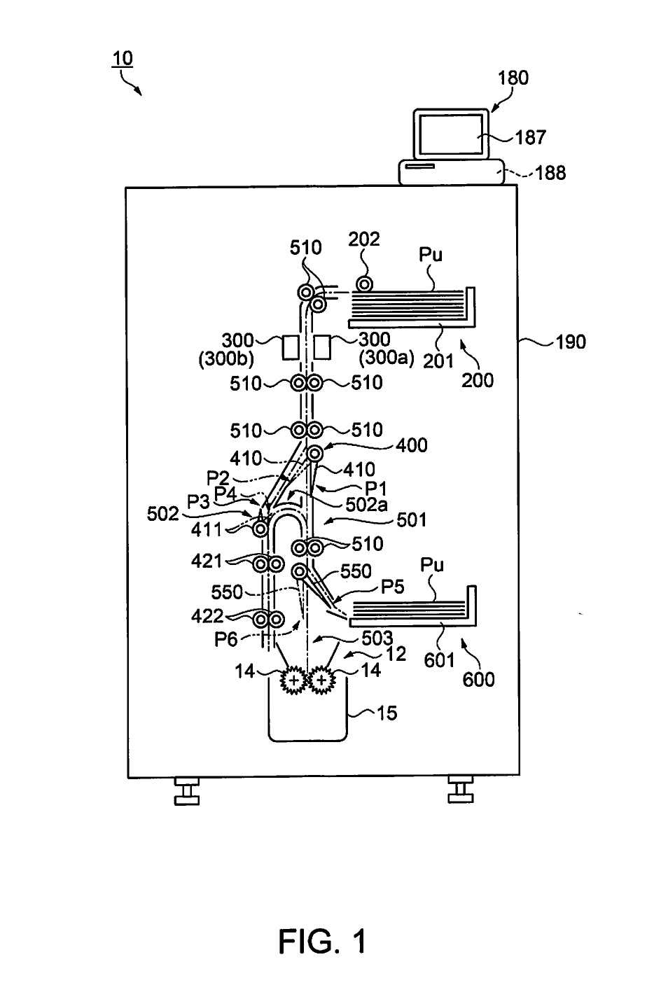

FIG. 1 schematically illustrates the configuration of the sheet processing device. As shown in FIG. 1, the sheet processing device 10 has a supply device 200, image acquisition device 300, and inverter 400. In this embodiment the sheet processing device 10 also has a shredder 12 and sheet stacker 600. The sheet processing device 10 also has a controller 180 that controls these other parts. The sheet processing device 10 also has a case 190, and the supply device 200, image acquisition device 300, inverter 400, shredder 12, and sheet stacker 600 are disposed inside the case 190. This configuration makes the sheet processing device 10 easier to use, and easily installed in an office environment, for example.

Note that the sensor of the image acquisition device may be a CCD area sensor, CMOS area sensor, or photodiode sensor, for example.

The sheet processing device 10 also has a first conveyance path 501 configured to discharge a sheet Pu to the sheet stacker 600 without reversing the first side and second side of the sheet Pu after the sheet Pu supplied from the supply device 200 passes through the image acquisition device 300; a second conveyance path 502 configured to discharge the sheet Pu to the sheet stacker 600 after reversing the first side and second side of the sheet Pu after the sheet Pu supplied from the supply device 200 passes through the image acquisition device 300; and a third conveyance path 503 configured to discharge the sheet Pu supplied from the supply device 200 to the shredder 12 after the sheet Pu passes through the image acquisition device 300. Multiple conveyance roller pairs 510 are disposed along the first to third conveyance paths 501, 502, 503. Note that in each conveyance roller pair 510, one roller is the drive roller and the other is a driven roller.

The supply device 200 supplies sheets Pu to the image acquisition device 300 side. In this example, the sheets Pu are recovered paper, such as A4 size paper commonly used in offices. The supply device 200 has a tray 201 in which multiple sheets Pu can be held in a stack, and an elevator mechanism for moving the tray 201 vertically. The elevator mechanism in this example has a ball screw shaft, a ball-nut connected to the tray 201, and a motor connected to the ball screw shaft, and moves the tray 201 vertically by driving the motor. A pick-up roller 202 is disposed to a position appropriate to the sheet Pu at the top of the stack of multiple sheets Pu on the tray 201. A sheet Pu is conveyed to the image acquisition device 300 side by driving the pick-up roller 202.

The image acquisition device 300 acquires an image of the sheet Pu supplied from the supply device 200. The image acquisition device 300 in this example is a scanner, and sends a data signal acquired by scanning the sheet Pu to the controller 180 as a first decision device. The image acquisition device 300 in this embodiment includes a first image acquisition device 300a that acquires an image of the first side of the supplied sheet Pu, and a second image acquisition device 300b that acquires an image of the second side of the supplied sheet Pu. The first image acquisition device 300a and second image acquisition device 300b are disposed facing each other with the sheet Pu passing therebetween. Note that this embodiment is configured to scan while moving the sheet Pu relative to the first and second image acquisition devices 300a, 300b, but may be configured to move the first and second image acquisition devices 300a, 300b relative to the sheet Pu.

When the controller 180 determines that the first side of the sheet Pu can be reused, the inverter 400 discharges the sheet Pu to the sheet stacker 600 side without reversing the first side and second side of the sheet Pu, and when the controller 180 determines that the second side of the sheet Pu can be reused, the inverter 400 reverses the first side and second side of the sheet Pu and then discharges the sheet Pu to the sheet stacker 600 side. The inverter 400 in this embodiment has a first diverter 410, second diverter 411, and inverter roller pairs 421 and 422.

The first diverter 410 is part of the first conveyance path 501, second conveyance path 502, and third conveyance path 503 at the junction between the first conveyance path 501 (third conveyance path 503) or second conveyance path 502. More specifically, the first diverter 410 in this example is a wedge-shaped member. The first diverter 410 is configured to move as driven by a motor, for example, pivoting on the end of the first diverter 410 on the upstream side in the conveyance direction of the sheet Pu. More specifically, the first diverter 410 is configured to move to a first position P1 or a second position P2. In this embodiment, when the first conveyance path 501 or third conveyance path 503 is selected, the first diverter 410 moves to the first position P1, and when the second conveyance path 502 is selected, the first diverter 410 moves to the second position P2.

Inverter roller pairs 421, 422 are disposed to the second conveyance path 502. Inverter roller pairs 421, 422 are rollers that can turn in both forward and reverse directions. In each of inverter roller pairs 421, 422, one roller is the drive roller and the other roller is the driven roller.

The second diverter 411 is disposed between the first diverter 410 and inverter roller pair 421, directs the sheet Pu conveyed from the first diverter 410 side to inverter roller pairs 421, 422, and discharges the sheet Pu conveyed in reverse by driving the inverter roller pairs 421, 422 in reverse to the sheet-inverting conveyance path 502a, which is connected to the second conveyance path 502 and first conveyance path 501. More specifically, the second diverter 411 is a wedge-shaped member. The second diverter 411 is configured to move as driven by a motor, for example, pivoting on the end of the second diverter 411 on the downstream side in the conveyance direction of the sheet Pu. More specifically, the second diverter 411 is configured to move to a third position P3 or fourth position P4. In this embodiment, when the sheet Pu is introduced to the side of the inverter roller pairs 421 and 422, the second diverter 411 is set to the third position P3; and when the reversed sheet Pu is discharged to the sheet-inverting conveyance path 502a, the second diverter 411 is set to the fourth position P4.

A third diverter 550 ID disposed to the first conveyance path 501 on the downstream side of the first diverter 410 in the conveyance direction of the sheet Pu. The third diverter 550 is part of the first and third conveyance paths 501, 503 at the junction between the first conveyance path 501 and third conveyance path 503. More specifically, the third diverter 550 is a wedge-shaped member. The third diverter 550 is configured to move as driven by a motor, for example, pivoting on the end of the third diverter 550 on the upstream side in the conveyance direction of the sheet Pu. More specifically, the third diverter 550 is configured to move to a fifth position P5 or a sixth position P6. In this embodiment, when the first conveyance path 501 is selected, the third diverter 550 moves to the fifth position P5, and when the third conveyance path 503 is selected, the third diverter 550 moves to the sixth position P6.

The sheet stacker 600 holds the sheets Pu discharged from the first conveyance path 501 or second conveyance path 502. The sheet stacker 600 has a tray 601 on which multiple discharged sheets Pu can be stacked.

The shredder 12 shreds the sheet Pu when the controller 180 determines that both the first side and second side of the sheet Pu cannot be reused. In this embodiment, sheets Pu conveyed through the third conveyance path 503 are shredded. The shredder 12 in this example shreds the sheets Pu into pieces approximately a few centimeters square. This prevents information recorded on the sheets Pu from leaking. The shredder 12 has shredder blades 14, and shreds (cuts) the sheets Pu introduced thereto with the shredder blades 14. The shredder 12 may be configured like a common paper shredder, for example. A shred receptacle 15 is also provided, and shreds produced by the shredder 12 are collected in the shred receptacle 15.

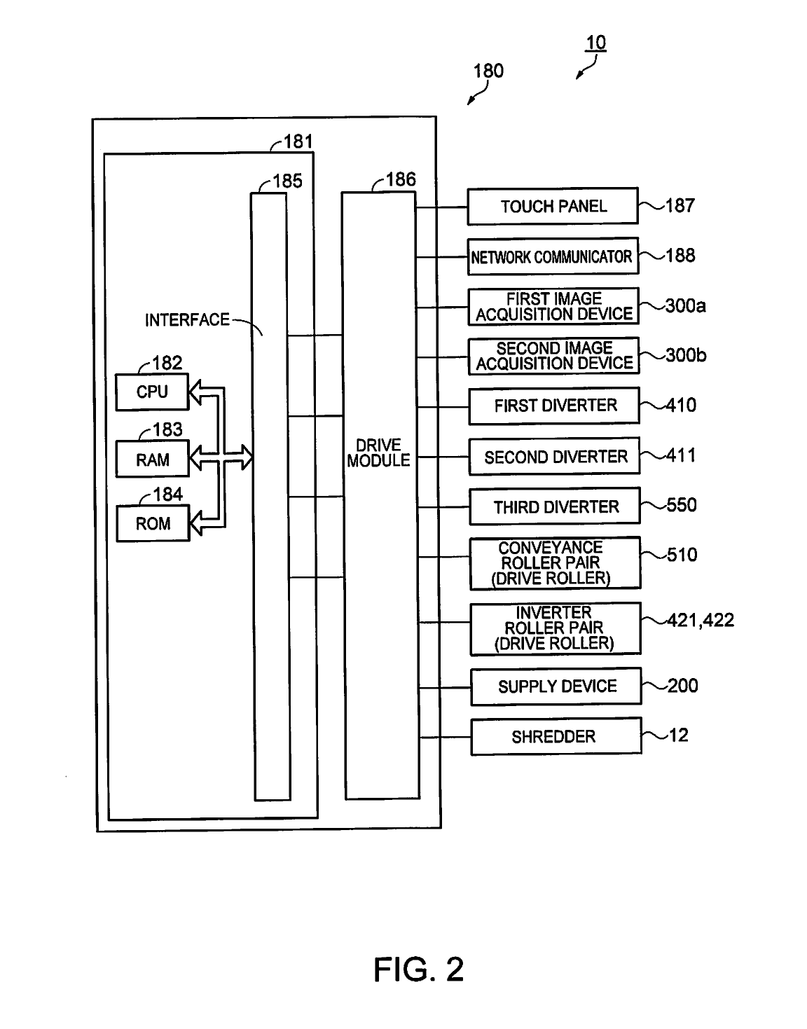

The control configuration of the sheet processing device is described next. FIG. 2 is a control block diagram illustrating the control configuration of the sheet processing device. As shown in FIG. 2, the controller 180 includes a command module 181 and a drive module 186. The command module 181 includes a CPU (central processing unit) 182 for executing programs, RAM (random access memory) 183 for temporarily storing data and programs, ROM (read-only memory) 184 in which data and programs are previously installed and stored nonvolatilely, and an interface 185. The CPU 182 processes signals input through the interface 185 based on data in RAM 183 and ROM 184, and outputs control signals through the interface 185 to the drive module 186.

The drive module 186 includes various drivers, and is connected to a touch panel 187, network communicator 188, first image acquisition device 300a, second image acquisition device 300b, first diverter 410, second diverter 411, third diverter 550, conveyance roller pair 510, inverter roller pairs 421, 422, supply device 200, and shredder 12. The drive module 186 is configured to control these parts and devices based on control signals from the command module 181.

The controller 180 (first decision device) determines, based on the image of a sheet Pu acquired by the image acquisition device 300, whether or not the sheet Pu can be reused. More specifically, the controller 180 determines whether or not a sheet Pu can be reused based on the recording state of the sheet Pu. The recording state of the sheet Pu includes, for example, whether or not content is printed on the sheet Pu by an inkjet printer or laser printer, or if there is handwritten content recorded using a writing instrument of some kind.

A specific example of a method of determining whether or not a sheet Pu can be reused is described next. This embodiment determines whether or not a sheet Pu can be reused based on data about the density of images on the sheet Pu. More specifically, the first image acquisition device 300a is first driven to scan the first side of the sheet Pu. An analog output signal of the surface image of the sheet Pu read by the first image acquisition device 300a is then converted to 8-bit pixel data by the A/D conversion process (not shown in the figure) of a digital converter, generating image data Pu′ corresponding to the image of the first side of the sheet Pu. The generated image data Pu′ is stored in RAM 183. The image data Pu′ includes pixel unit density data. This density data is a data value that can be expressed by 256 gradations, for example. Previously stored reference density data is then compared with the density data generated for the image data Pu′. The reference density data is density data acquired from the surface of a sheet Pu on which nothing is recorded, for example. If the value of the density data of the image data Pu′ is greater than the value of the reference density data, it is determined that something is recorded on the surface of the sheet Pu, and the sheet Pu cannot be reused. However, if the value of the density data of the image data Pu′ is less than the value of the reference density data, it is determined that nothing is recorded on the surface of the sheet Pu, and the sheet Pu can be reused. Note that the same evaluation is made for the second side of the sheet Pu.

The controller 180 (first decision device) also has a second decision device that determines, based on the image of the sheet Pu acquired by the image acquisition device 300, if there is a problem with the surface condition of the sheet Pu. A problem with the surface condition of the sheet Pu refers to whether or not the sheet Pu is wrinkled, creased, torn, or soiled, for example. Problems with the surface condition of the sheet Pu are determined irrespective of the first side and second side of the sheet Pu. Note that the method of determining whether or not there is a problem with the surface condition of the sheet Pu can also be based on the density data for the image of the sheet Pu described above. More specifically, if the sheet Pu is wrinkled, creased, torn, or soiled, the amount of light that is reflected when the sheet Pu is scanned with the image acquisition device 300 differs where the sheet Pu is wrinkled, creased, torn, or soiled and where the sheet Pu is not wrinkled, creased, torn, or soiled, producing differences in the density data. As a result, whether or not there is a problem with the surface condition of the sheet Pu can be determined by comparing the previously stored reference density data and the density data generated for the image data Pu′.

The method of comparing the previously stored reference density data and the density data generated for the image data Pu′ in the controller 180′ is not limited to the method described above, and may, for example, calculate the average of the density data generated for the image data Pu′ and use the calculated average for comparison, or use a digitized value based on a specific threshold in the density data generated for the image data Pu′ for comparison. Further alternatively, various spatial filtering processes (such as a Prewitt filter or Sobel filter) may be applied when calculating density data based on the image data Pu′ to better define differences between the density data for a specific pixel or pixels neighboring the specific pixel, and the density data of pixels in other areas.

A sheet processing method is described next. The sheet processing method supplies a sheet, acquires an image of the supplied sheet, determines whether or not the sheet can be reused based on the acquired image of the sheet, discharges the sheet without reversing the first side and second side of the sheet if the first side of the sheet is determined to be reusable, and discharges the sheet after reversing the first side and second side of the sheet if the second side of the sheet is determined to be reusable. This method is described more specifically below. Note that the sheet processing method of this embodiment is described as the sheet processing method of the sheet processing device 10 described above.

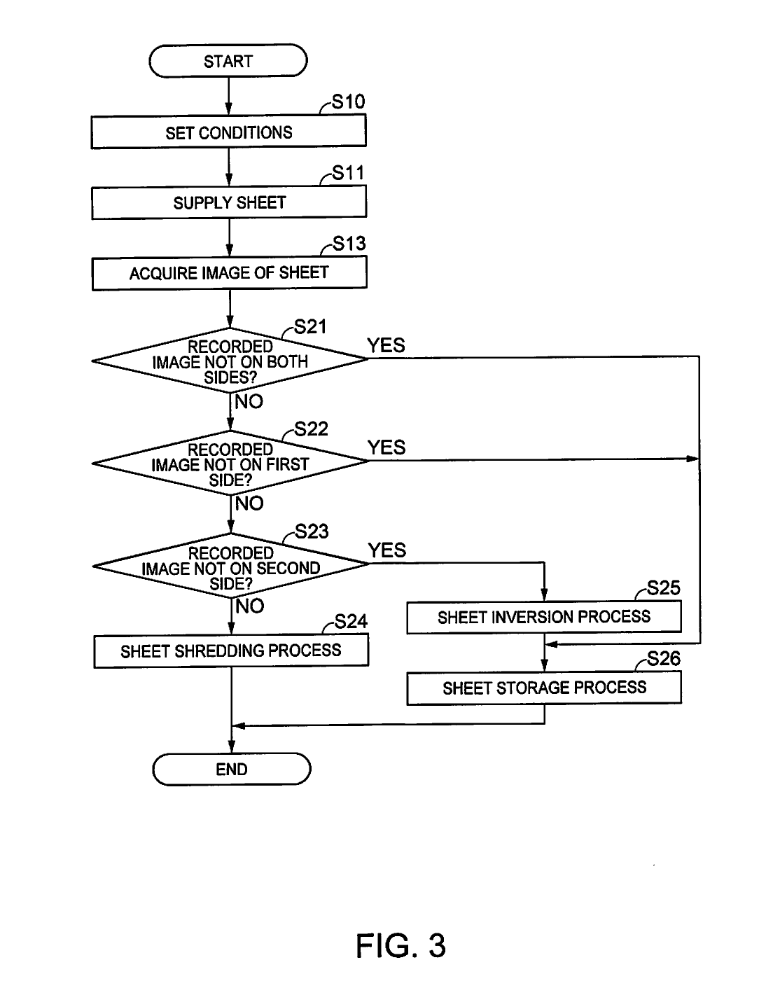

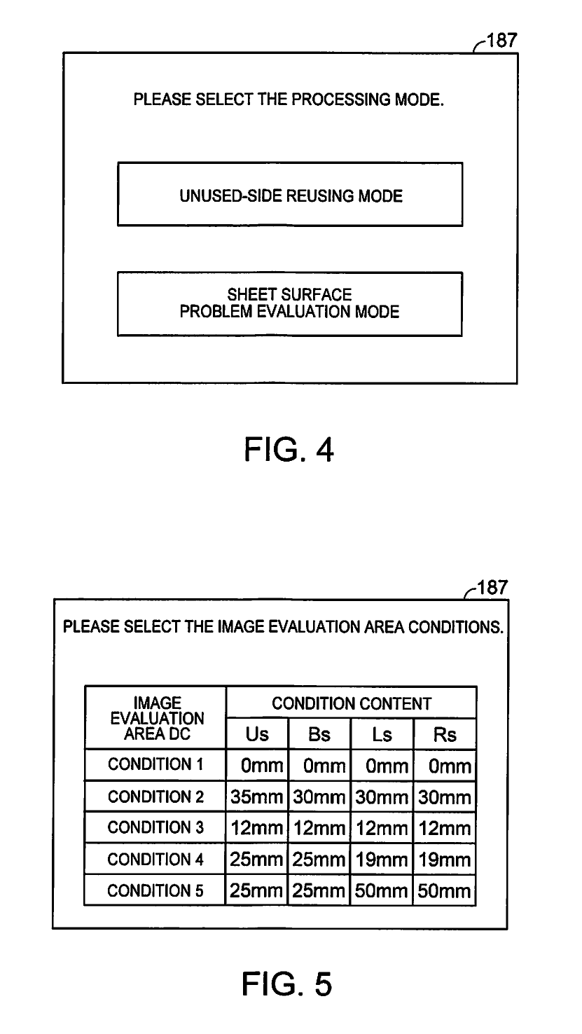

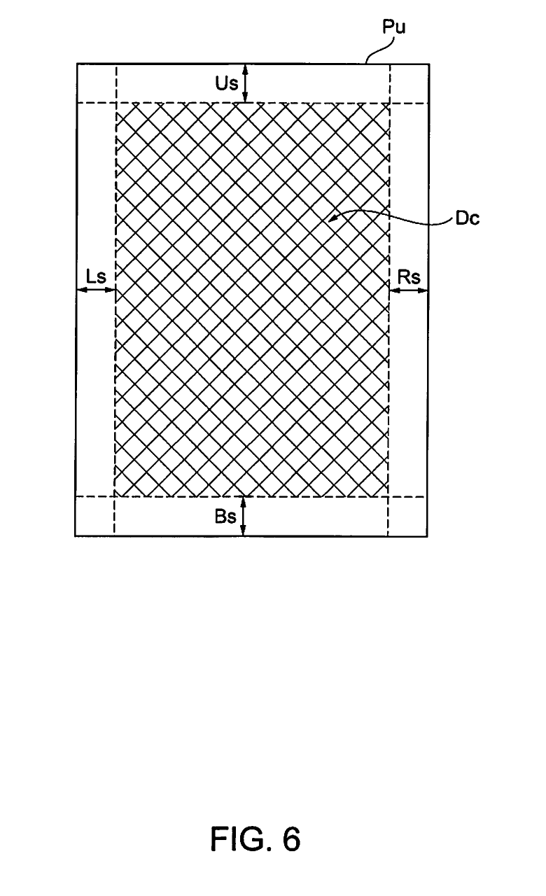

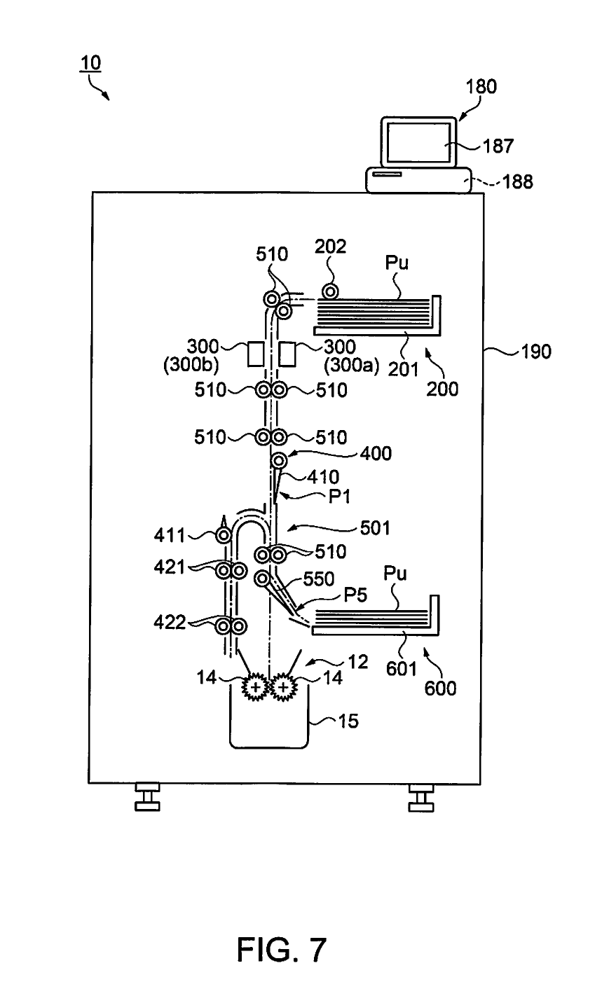

FIG. 3 is a flow chart of the sheet processing method. FIG. 4 and FIG. 5 show examples of screens displayed on the touch panel, and FIG. 6 describes conditions for evaluating the image evaluation area. FIG. 7 to FIG. 10 illustrate operation of the sheet processing device. This embodiment describes two sheet processing methods executed by the sheet processing device 10: a method that enables reusing the sheet Pu when a sheet Pu is processed by evaluating only the recording state of the sheet Pu and either the first side or the second side of the sheet Pu is determined to be unused (an unused-side reusing mode); and a method that, in addition to evaluating the recording state of the sheet Pu, processes the sheet Pu based on determining if there is a problem with the surface condition of the sheet Pu (a sheet surface problem evaluation mode).

The unused-side reusing mode is described first. As shown in FIG. 3, conditions are first set in step S10. More specifically, the sheet processing method is selected, and conditions for evaluating whether or not the sheet Pu can be reused are set. First, as shown in FIG. 4, of the unused-side reusing mode and sheet surface problem evaluation mode displayed in the sheet processing mode selection screen presented on the touch panel 187, the unused-side reusing mode is selected by using a finger or stylus, for example.

Next, the conditions for the image evaluation area are selected. Reusability may be determined based on whether or not the entire first side or second side of the sheet Pu is covered with recording (printing), but reusing sheets Pu with printing in a relatively small area at an end of the sheet Pu may also be desirable. As a result, the user can select the conditions of the image evaluation area used to determine if a sheet Pu can be reused according to how the user intends to reuse the sheet Pu.

More specifically, as shown in FIG. 5 and FIG. 6, the user selects the image evaluation area Dc for evaluating the recording state in the image of the sheet Pu. Note that conditions (dimensions) defining where to exclude from evaluation for the presence of recording on the sheet Pu are displayed in the conditions (FIG. 5) of the image evaluation area Dc.

More specifically, margin Us from one short side of the sheet Pu toward the other short side; margin Bs from the other short side of the sheet Pu toward the one short side; margin Ls from one long side of the sheet Pu toward the other long side; and margin Rs from the other long side of the sheet Pu toward the one long side, are defined. In condition 1 of the image evaluation area Dc, margin Us is 0 ram, margin Bs is 0 mm, margin Ls is 0 mm, and margin Rs is 0 mm. In other words, the image evaluation area Dc according to condition 1 is the entire surface of the sheet Pu. Therefore, by selecting condition 1, the recording state of the entire surface of the first side and second side of the sheet Pu is evaluated.

In condition 2 of the image evaluation area Dc, margin Us is 35 ram, margin Bs is 30 mm, margin Ls is 30 mm, and margin Rs is 30 mm. More specifically, the image evaluation area Dc according to condition 2 is an area excluding the area indicated by the these margin dimensions from the entire surface of the sheet Pu. Therefore, by selecting condition 2, the recording state is evaluated only in the area excluding the areas indicated by the these margins even if something is recorded inside these margins. This also applies to condition 3 to condition 5. Note that the conditions defining the image evaluation area Dc are not specifically limited, and can be appropriately set or changed according size of the sheet Pu or how the sheet is to be reused, for example.

A sheet Pu is then supplied in step S11. More specifically, the pick-up roller 202 of the supply device 200 is driven to supply a sheet Pu from the tray 201 to the first image acquisition device 300a and second image acquisition device 300b side.

Next, in step S13, images of the supplied sheet Pu are acquired. Specifically, as shown in FIG. 7, the first image acquisition device 300a and second image acquisition device 300b are driven, the first image acquisition device 300a acquires an image of the first side of the sheet Pu, and the second image acquisition device 300b acquires an image of the second side of the sheet Pu. More specifically, an analog output signal of the images of the surface of the sheet Pu acquired by the first image acquisition device 300a and second image acquisition device 300b is converted to 8-bit pixel data by the A/D conversion process (not shown in the figure) of a digital conversion means, generating image data Pu′ corresponding to the images of the first side and second side of the sheet Pu. The image data Pu′ acquired by the first image acquisition device 300a and second image acquisition device 300b is then stored on the storage device of a specific server by accessing the server through the network communicator 188. As a result, because the image data Pu′ is stored on a server, specific image data Pu′ can be read from the server and the recorded information regenerated even after the sheet Pu is shredded (cut) by the sheet processing device 10.

Next, in step S21, based on the conditions set in step S10, whether or not there is a recorded image in the image data Pu′ corresponding to the image acquired from the first side of the sheet Pu, and in the image data Pu′ corresponding to the image acquired from the second side of the sheet Pu, is determined. If there is a recorded image in the image data Pu′ of the first side or second side (NO), control goes to step S22.

However, if there is not a recorded image in the image data Pu′ corresponding to the first side and second side of the sheet Pu (YES), control goes to step S26, and the storage process of the sheet Pu is executed in step S26. At this time, for the sheet Pu to pass through the first conveyance path 501, the first diverter 410 is set to the first position P1, and the third diverter 550 is set to the fifth position P5. As a result, the sheet Pu that has passed through the first image acquisition device 300a and second image acquisition device 300b is carried through the first conveyance path 501 by the conveyance roller pair 510, and stored in the sheet stacker 600. In other words, when both sides of the sheet Pu are determined by the controller 180 to be reusable, the sheet Pu is discharged without being reversed. Note that in this embodiment, the sheet Pu is stored in the sheet stacker 600 with the first side facing up.

Next, in step S22, based on the conditions set in step S10, whether or not there is a recorded image in the image data Pu′ corresponding to the image acquired from the first side of the sheet Pu is determined. If there is a recorded image (NO), control goes to step S23.

However, if there is not a recorded image in the image data Pu′ corresponding to the first side of the sheet Pu (YES), control goes to step S26, and the storage process of the sheet Pu is executed in step S26. At this time, for the sheet Pu to pass through the first conveyance path 501, the first diverter 410 is set to the first position P1, and the third diverter 550 is set to the fifth position P5. As a result, the sheet Pu that has passed through the first image acquisition device 300a and second image acquisition device 300b is carried through the first conveyance path 501 by the conveyance roller pair 510, and stored in the sheet stacker 600. In other words, the first side of the sheet Pu is determined by the controller 180 to be reusable, the sheet Pu is discharged without being reversed. Note that in this embodiment, the sheet Pu is stored in the sheet stacker 600 with the first side facing up. As a result, as when there is not a recorded image in the image data Pu′ corresponding to the first side and second side of the sheet Pu, the sheet Pu is stored with the side on which there is not a recorded image (the first side) facing up.

Next, in step S23, based on the conditions set in step S10, whether or not there is a recorded image in the image data Pu′ corresponding to the image acquired from the second side of the sheet Pu is determined. If there is a recorded image (NO), control goes to step S24.

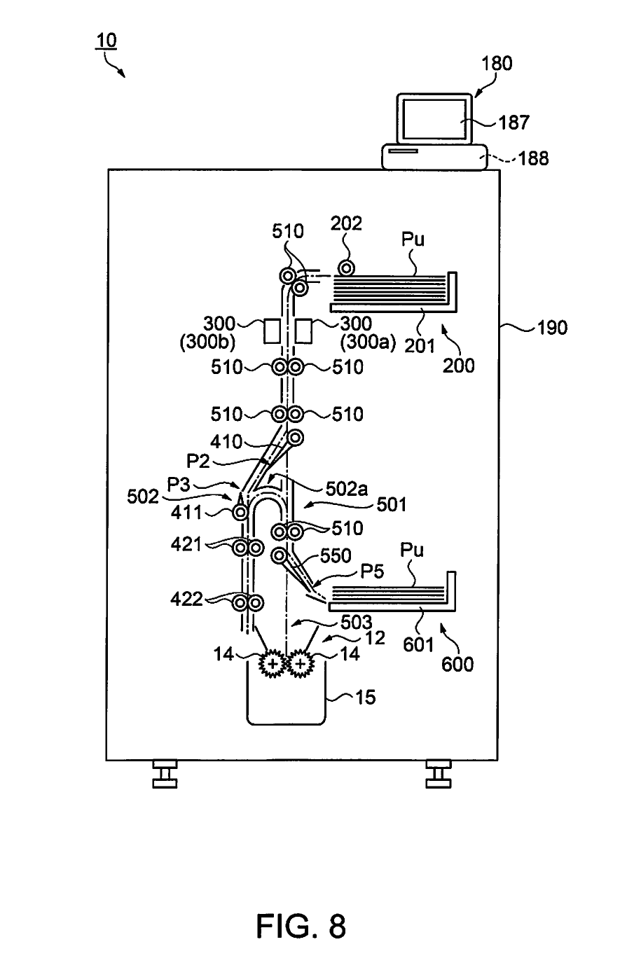

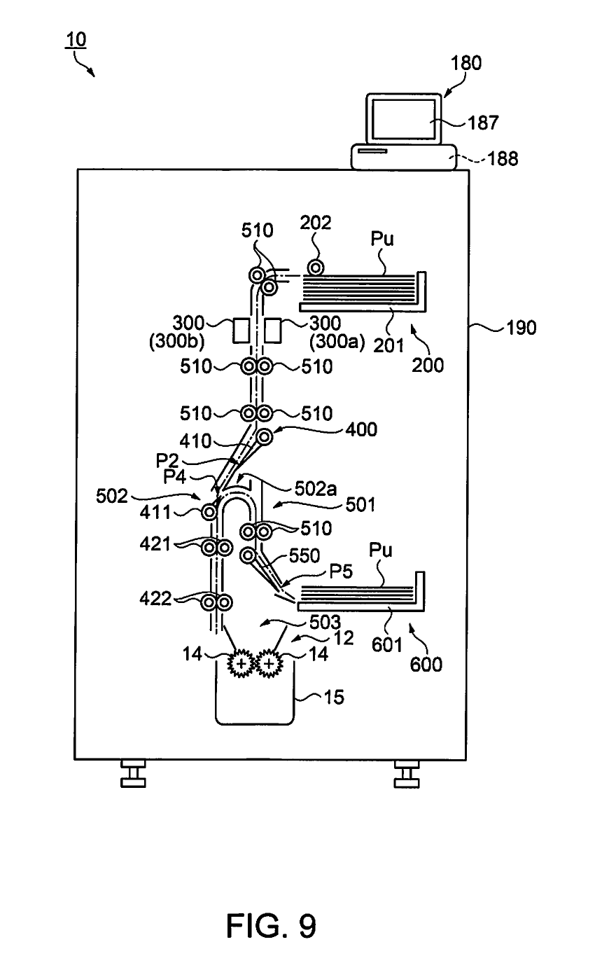

If there is not a recorded image in the image data Pu′ corresponding to the second side of the sheet Pu (YES), control goes to step S25, and the sheet Pu reversing process is executed in step S25. Because the sheet Pu passes through the second conveyance path 502 in this event, as shown in FIG. 8, the first diverter 410 is set to the second position P2, and the second diverter 411 is set to the third position P3. As a result, the sheet Pu that has passed through the first image acquisition device 300a and second image acquisition device 300b is then conveyed by the conveyance roller pair 510 from the first conveyance path 501 to the second conveyance path 502. The sheet Pu is conveyed by also driving the inverter roller pairs 421, 422 to turn forward. The sheet Pu is then conveyed until the end of the sheet Pu on the downstream side in the conveyance direction passes through the second diverter 411. Next, as shown in FIG. 9, the second diverter 411 is moved from the third position P3 to the fourth position P4. The inverter roller pairs 421 and 422 are then driven in reverse. As a result, the sheet Pu is reversed, conveyed by the second diverter 411 through the sheet-inverting conveyance path 502a, and merges into the first conveyance path 501.

Control then goes to step S26, and the sheet Pu storage process is executed in step S26. At this time, the third diverter 550 is set to the fifth position P5. As a result, the sheet Pu is stored by the conveyance roller pair 510 through the third diverter 550 into the sheet stacker 600. More specifically, when the second side of the sheet Pu is determined by the controller 180 to be reusable, the sheet Pu is discharged with the first side and second side reversed. The sheet Pu is also stored with the side on which there is not a recorded image (the second side) facing up.

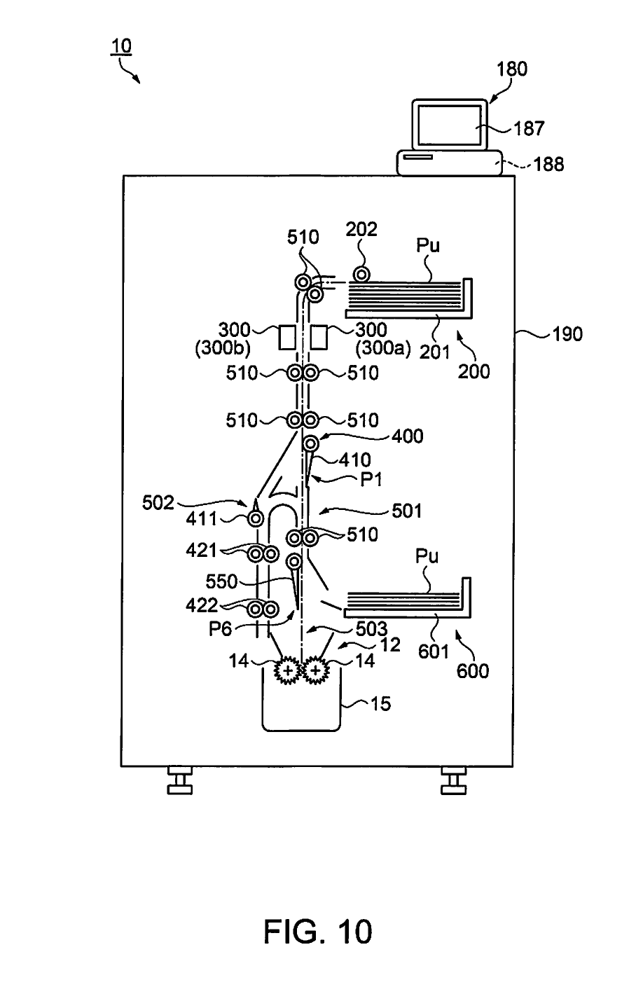

Next, the sheet Pu shredding process is executed in step S24. More specifically, when the controller 180 determines that both the first side and second side of the sheet Pu are not reusable, the sheet Pu is shredded by the shredder 12. As shown in FIG. 10, in this event the first diverter 410 is set to the first position P1, and the third diverter 550 is set to the sixth position P6. As a result, the sheet Pu that has passed through the first image acquisition device 300a and second image acquisition device 300b is conveyed by the conveyance roller pair 510 from the first conveyance path 501 to the third conveyance path 503. The sheet Pu is then conveyed to the shredder 12, and the sheet Pu is shredded (cut) by the shredder blades 14 of the shredder 12. As a result, information recorded on a sheet Pu that cannot be reused can be prevented from leaking.

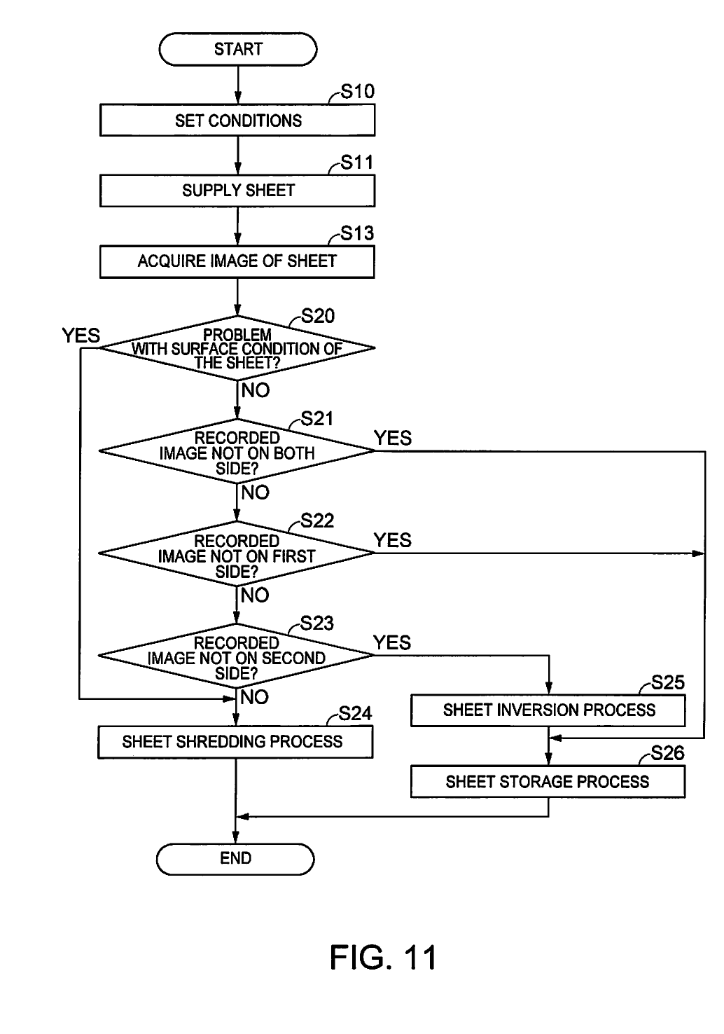

Another sheet processing method is described next. More specifically, a sheet surface problem evaluation mode is described. FIG. 11 is a flow chart of this other sheet processing method. As shown in FIG. 11, conditions are set in step S10. More specifically, as shown in FIG. 4, of the unused-side reusing mode and sheet surface problem evaluation mode displayed in the sheet processing mode selection screen presented on the touch panel 187, the sheet surface problem evaluation mode is selected by using a finger or stylus, for example. Note that the other condition setting method in step S10 is the same as described above, and further description thereof is omitted.

Next, control goes to step S11, and then to step S13. Note that step S11 and step S13 are the same as described above, and further description thereof is omitted. Control then goes from step S13 to step S20.

In step S20, whether or not there is a problem with the surface condition of the sheet Pu is determined based on the image data Pu′ corresponding to the acquired sheet Pu. If there is a problem with the surface condition (YES), control goes to step S24. More specifically, when it is determined by the controller 180 that there is a problem with the surface condition of the sheet Pu, that sheet Pu is shredded by the shredder 12. As shown in FIG. 10, in this event the first diverter 410 is set to the first position P1, and the third diverter 550 is set to the sixth position P6. As a result, the sheet Pu that has passed through the first image acquisition device 300a and second image acquisition device 300b is sent by the conveyance roller pair 510 from the first conveyance path 501 to the third conveyance path 503. The sheet Pu is then conveyed to the shredder 12, and the sheet Pu is shredded (cut) by the shredder blades 14 of the shredder 12. As a result, information recorded on a sheet Pu that cannot be reused can be prevented from leaking.

However, if in step S20 there is not a problem with the surface condition (NO), control goes to step S21. Note that because processing from step S21 is as described above, further description thereof is omitted.

Effects of this embodiment are described below.

An image (image data Pu′) of the sheet Pu supplied from the supply device 200 is acquired by the first and second image acquisition devices 300a, 300b, and based on the acquired image (image data Pu′) of the sheet Pu, whether or not the sheet Pu can be reused is determined. As a result, opportunities to effectively utilize sheets can be increased, and sheet consumption can be suppressed. In addition, the sheets Pu are discharged with the reusable sides facing the same direction by the inverter 400. Because the reusable sides of the sheets Pu are stacked in the sheet stacker 600 facing up, the sheets Pu can be reused immediately. Whether or not a sheet Pu can be reused is also determined based on the presence of problems with the surface condition of the sheet Pu. As a result, sheets Pu that are unsuitable for reuse can be reliably separated.

### Embodiment 2

A second embodiment of the invention is described next. A sheet processing device according to this embodiment of the invention has a supply device that supplies sheets; an image acquisition device that acquires an image of a sheet supplied from the supply device; a first decision device that determines whether or not a sheet can be reused based on the images of the sheet acquired by the image acquisition device; and an inverter that, when the first decision device determines the first side of the sheet can be reused, discharges the sheet without reversing the first side and second side of the sheet, and when the first decision device determines the second side of the sheet can be reused, reverses the first side and second side of the sheet and then discharges the sheet.

The sheet processing device according to this embodiment of the invention may also have an eraser device that is disposed in the conveyance direction of the sheet between the supply device and the image acquisition device, and erases images recorded on passing sheets.

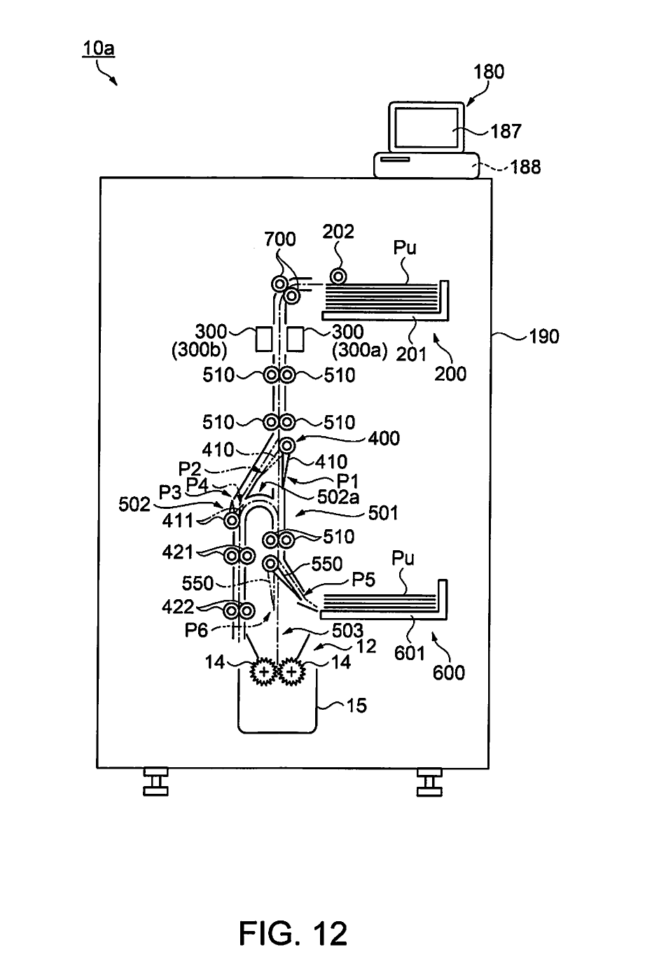

FIG. 12 schematically illustrates the configuration of a sheet processing device. As shown in FIG. 12, the sheet processing device 10a includes a supply device 200, image acquisition device 300, inverter 400, shredder 12, sheet stacker 600, and eraser device 700. The sheet processing device 10a also has a controller 180 that controls these other parts. Note that except for the eraser device 700, the configuration of this embodiment is the same as the configuration of the first embodiment, and further description thereof is omitted.

The eraser device 700 is a device that erases images recorded on a sheet Pu.

Decolorizing is described below.

Inks that lose color in response to a specific action can be used as erasable ink usable in an inkjet process. Examples of such erasable inks include inks that lose color when exposed to light energy or heat energy.

Inks including a photochromic compound can be used as an ink that loses color when light energy is applied. Inks made with a leuco dye and a developer can be used as an ink that loses color when heat energy is applied.

Toners that lose color in response to a specific action can be used as erasable toners as an erasable ink in an electrophotographic process. Examples of such erasable toners include toners that lose color when light energy or heat energy is applied.

Toners including a near-infrared light sensitive dye and decolorizing agent can be used as a toner that loses color when light energy is applied.

Toners made with a leuco dye, a developer, and a binder resin can be used as a toner that loses color when heat energy is applied. This heat sensitive erasable toner includes microcapsules containing a leuco dye, developer, and temperature control agent, a thermoplastic resin, and wax, and when heat is applied, molecular vibration occurs, and the pigment and developer bonds break. The pigment turns colorless by causing the erasing agent and pigment to bond, and color can be erased.

Note that a configuration for erasing images recorded using an erasable toner or erasable ink characterized by losing color when heat is applied is described in this embodiment.

The eraser device 700 in this embodiment is a pair of heat rollers (heater roller pair), and is disposed between the supply device 200 and image acquisition device 300. A heater or other heating member is disposed in the center of the spindle of each heat roller, and is configured so that the entire heater roller is heated by driving the heater. The heating temperature is from approximately 30° C. to 70° C., for example. The sheet Pu is heated, and images recorded with erasable ink are erased, by passing the sheet Pu supplied from the supply device 200 between the heat roller pair. A sheet Pu that has passed through the eraser device 700 is then conveyed to the image acquisition device 300 side.

The control configuration of the specified is described next.

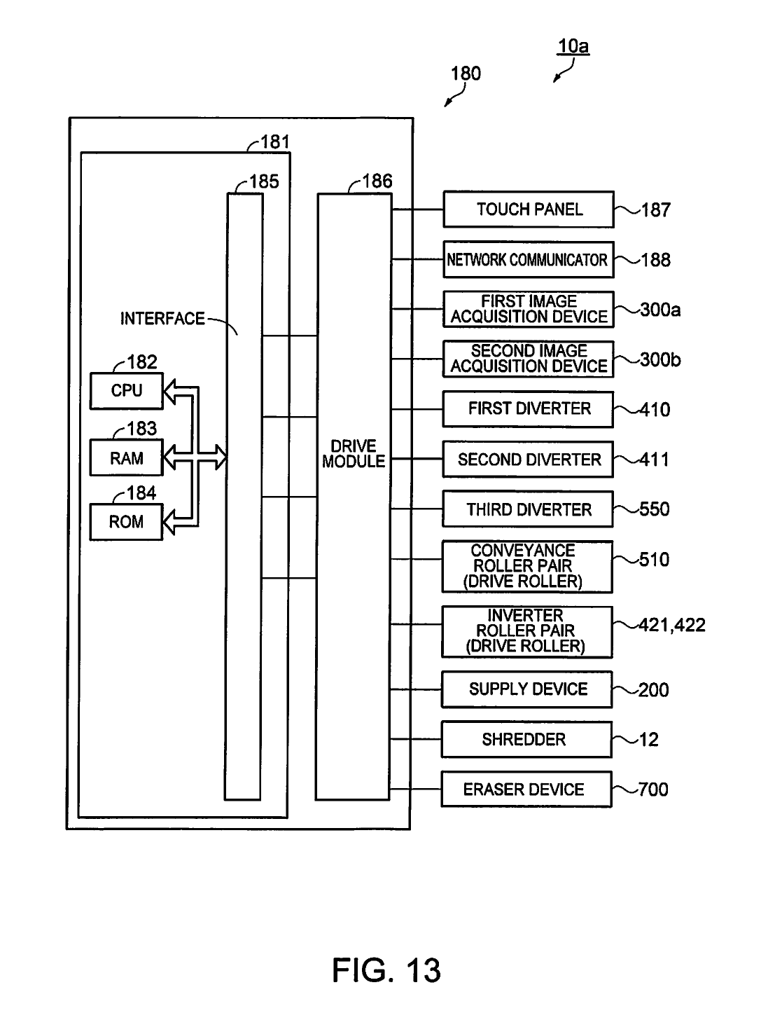

FIG. 13 is a control block diagram illustrating the control configuration of the sheet processing device. As shown in FIG. 13, the controller 180 includes a command module 181 and a drive module 186. In this embodiment, the eraser device 700 is connected to the drive module 186, and can be controlled based on control signals from the command module 181. Note that other aspects of the configuration are the same as the configuration described in the first embodiment, and further description thereof is omitted.

The sheet processing method is described next.

The sheet processing method supplies a sheet, erases the images recorded on the supplied sheet, then acquires an image of the supplied sheet, determines whether or not the sheet can be reused based on the acquired image of the sheet, discharges the sheet without reversing the first side and second side of the sheet if the first side of the sheet is determined to be reusable, and discharges the sheet after reversing the first side and second side of the sheet if the second side of the sheet is determined to be reusable. This method is described more specifically below. Note that the sheet processing method of this embodiment is described as the sheet processing method of the sheet processing device 10a described above.

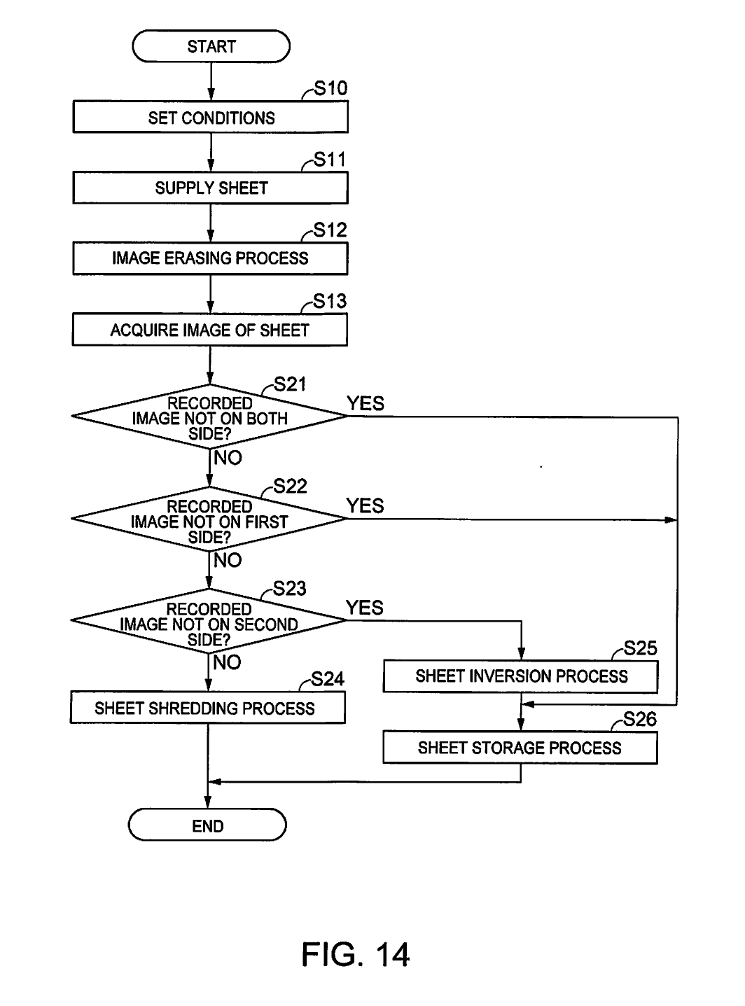

Of the unused-side reusing mode and the sheet surface problem evaluation mode, the unused-side reusing mode is described first. FIG. 14 is a flow chart of the sheet processing method.

As shown in FIG. 14, conditions are set in step S10. More specifically, of the unused-side reusing mode and sheet surface problem evaluation mode displayed in the sheet processing method selection screen presented on the touch panel 187, the unused-side reusing mode is selected by tapping with the finger or stylus, for example (see FIG. 4). Next, the conditions for determining whether or not the sheet Pu can be reused are selected. Note that because the specific content of this selection method is the same as in the first embodiment, further description thereof is omitted. Next, in step S11, a sheet Pu is supplied. Note that because the specific content of this operation is the same as in the first embodiment, further description thereof is omitted.

Next, in step S12, images recorded on the supplied sheet Pu are erased. More specifically, the sheet Pu is conveyed through the heated eraser device 700 (heat roller pair). As a result, the sheet Pu (erasable ink) is heated, and images recorded by erasable ink are erased.

Next, in step S13, images of the supplied sheet Pu are acquired. Specifically, as shown in FIG. 12, the first image acquisition device 300a and second image acquisition device 300b are driven, the first image acquisition device 300a acquires image data Pu′ corresponding to the first side of the sheet Pu, and the second image acquisition device 300b acquires image data Pu′ corresponding to the second side of the sheet Pu.

Next, in step S21, based on the conditions set in step S10, whether or not there is a recorded image in the image data Pu′ corresponding to the image acquired from the first side of the sheet Pu, and in the image data Pu′ corresponding to the image acquired from the second side of the sheet Pu, is determined. If there is a recorded image in the image data Pu′ of the first side or second side (NO), control goes to step S22.

However, if there is not a recorded image in the image data Pu′ corresponding to the first side and second side of the sheet Pu (YES), control goes to step S26, and the storage process of the sheet Pu is executed in step S26. Here, because a sheet Pu recorded with an erasable ink that can be decolorized by heating is erased (decolorized) by the eraser device 700, it is determined that there is not a recorded image. However, if the sheet Pu was recorded using an ink other than an erasable ink that can be decolorized by heating, or by another writing instrument, the image on the sheet Pu cannot be erased. In this case, it is determined that there is a recorded image. Therefore, if the sheets Pu supplied from the supply device 200 include a mixture of sheets Pu that were recorded with an erasable ink that can be decolorized by heating, and sheets Pu that were recorded using an ink other than an erasable ink that can be decolorized by heating, sheets that can be reused can be reliably separated.

Note that the content of the steps from step S21 are the same as in the first embodiment, and further description thereof is omitted.

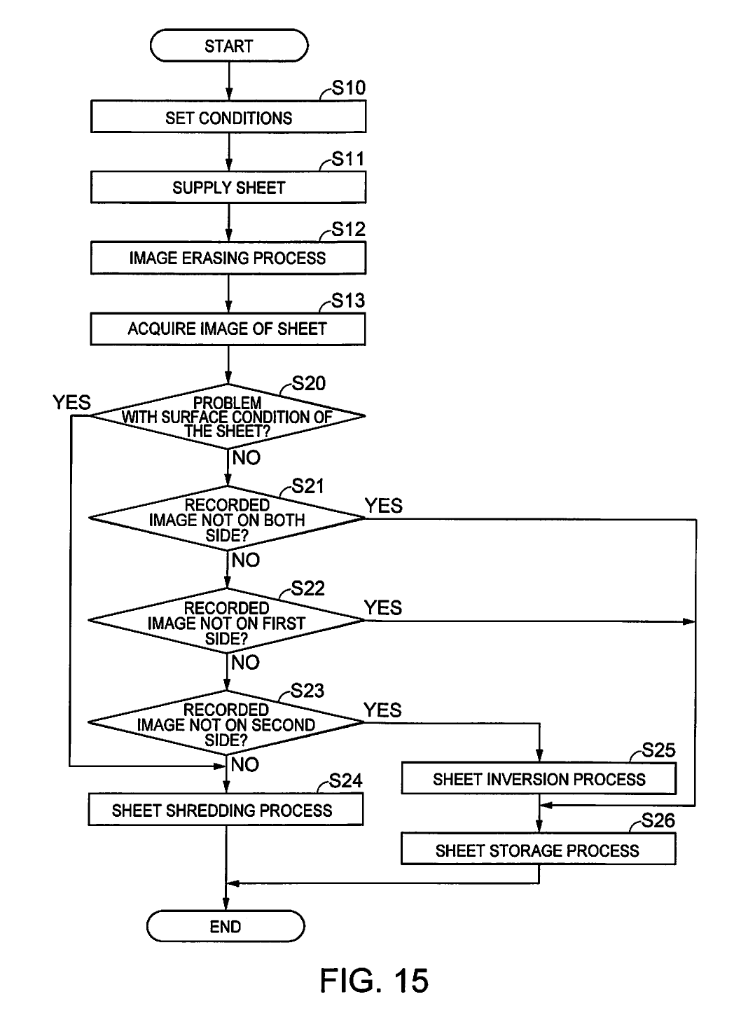

Another sheet processing method is described next. More specifically, a sheet surface problem evaluation mode is described. FIG. 15 is a flow chart of this other sheet processing method. As shown in FIG. 15, conditions are first set in step S10. More specifically, of the unused-side reusing mode and sheet surface problem evaluation mode displayed in the sheet processing mode selection screen presented on the touch panel 187, the sheet surface problem evaluation mode is selected by using a finger or stylus, for example (see FIG. 4). Next, the conditions for determining whether or not a sheet Pu can be reused are selected. Note that because the content of this method is the same as the content described in the first recording medium, further description thereof is omitted. Next, in step S11, a sheet Pu is supplied. Note that because the specific content of this operation is the same as in the first embodiment, further description thereof is omitted.

Next, in step S12, images recorded on the supplied sheet Pu are erased. More specifically, the sheet Pu is conveyed through the heated eraser device 700 (heat roller pair). As a result, the sheet Pu (erasable ink) is heated, and images recorded by erasable ink are erased.

Next, in step S13, images of the supplied sheet Pu are acquired. Specifically, as shown in FIG. 12, the first image acquisition device 300a and second image acquisition device 300b are driven, the first image acquisition device 300a acquires image data Pu′ corresponding to the first side of the sheet Pu, and the second image acquisition device 300b acquires image data Pu′ corresponding to the second side of the sheet Pu.

Next, in step S20, whether or not there is a problem with the surface condition of the sheet Pu is determined based on the image data Pu′ corresponding to the acquired sheet Pu. If there is a problem with the surface condition (YES), control goes to step S24. More specifically, when it is determined by the controller 180 that there is a problem with the surface condition of the sheet Pu, that sheet Pu is shredded by the shredder 12. However, if in step S20 there is not a problem with the surface condition (NO), control goes to step S21.

Here, a sheet Pu recorded with an erasable ink that can be decolorized by heating is erased (decolorized) by the eraser device 700, but cannot be reused if it is determined that there is a problem with the surface condition of the sheet Pu. As a result, that sheet Pu is shredded by the shredder 12. Therefore, even sheets Pu from which images can be erased can be reliably separated into sheets Pu that can be reused and sheets Pu that cannot be reused based on the surface condition of the sheets Pu.

Note that the content of the steps from step S20 are the same as in the first embodiment, and further description thereof is omitted.

Effects of this embodiment are described below.

Images recorded in a leuco dye ink on a sheet Pu are erased (decolorized) by the eraser device 700. As a result, opportunities to utilize sheets can be increased, and sheet consumption can be suppressed.

### Embodiment 3

A third embodiment of the invention is described next. A sheet processing device according to this embodiment of the invention has a supply device that supplies sheets; an image acquisition device that acquires an image of a sheet supplied from the supply device; a first decision device that determines whether or not a sheet can be reused based on the images of the sheet acquired by the image acquisition device; an inverter that, when the first decision device determines the first side of the sheet can be reused, discharges the sheet without reversing the first side and second side of the sheet, and when the first decision device determines the second side of the sheet can be reused, reverses the first side and second side of the sheet and then discharges the sheet; a shredder that shreds sheets; a defibrator that defibrates the shreds shredded by the shredder into defibrated material; and a sheet forming device that forms sheets using at least part of the defibrated material. The specific configuration is described below.

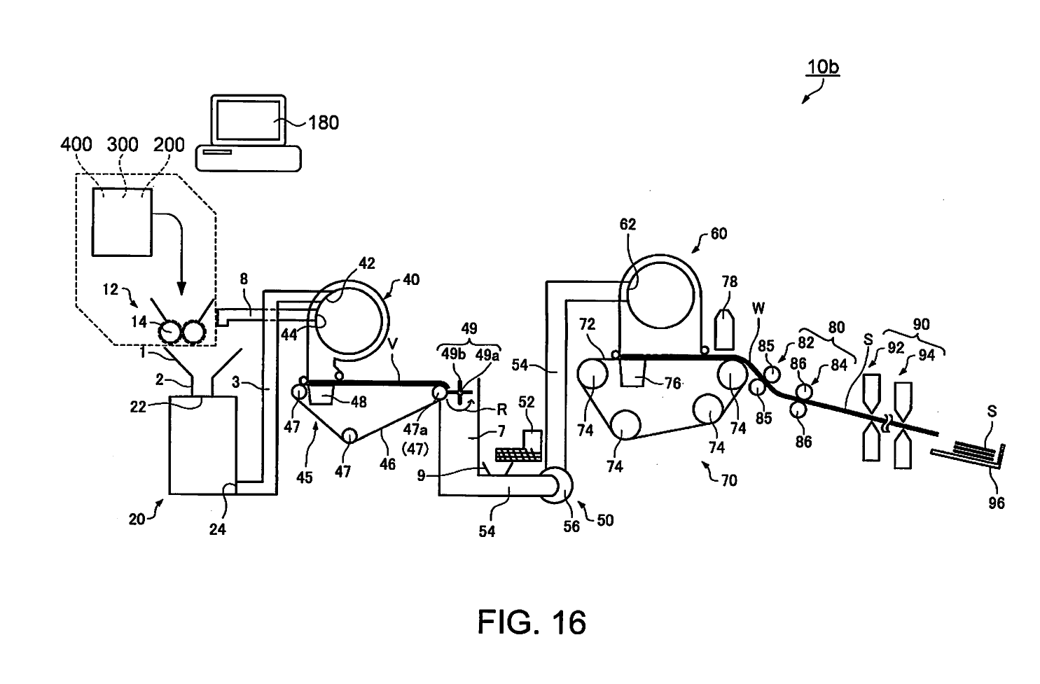

FIG. 16 schematically illustrates the configuration of a sheet processing device according to this embodiment of the invention. As shown in FIG. 16, the sheet processing device 10b includes a supply device 200, an image acquisition device 300, an inverter 400, a shredder 12, a defibrator 20, and a sheet forming device 80. The sheet processing device 10b also includes a controller 180 (first decision device) that controls these other parts. The configuration of the supply device 200, image acquisition device 300, inverter 400, and shredder 12 are the same as in the first embodiment, and further description thereof is omitted.

The defibrator 20 defibrates the feedstock shredded by the shredder 12 and conveyed through the hopper 1 and conduit 2. Defibrate as used here is a process of separating feedstock (material to be defibrated) comprising interlocked fibers into individual detangled fibers. The defibrator 20 also functions to separate particulate such as resin, ink, toner, and sizing agents in the feedstock from the fibers.

Material that has passed through the defibrator 20 is referred to as defibrated material. In addition to untangled fibers, the defibrated material may also contain resin particles (resin used to bind multiple fibers together), coloring agents such as ink and toner, sizing agents, paper strengthening agents, and other additives that are separated from the fibers when the fibers are detangled. The shape of the detangled defibrated material is a string or ribbon. The detangled, defibrated material may be separated from (not interlocked with) other detangled fibers, or may be in lumps interlocked with other detangled defibrated material (in so-called fiber clumps).

The defibrator 20 defibrates in a dry process in ambient air (air). More specifically, an impeller mill is used as the defibrator 20. The defibrator 20 has the function of creating an air flow that sucks in the feedstock and then discharges the defibrated material. As a result, the defibrator 20 can suction the feedstock with the air flow from the inlet 22, defibrate, and then convey the defibrated material to the exit 24 using the air flow produced by the defibrator 20. The defibrated material that has passed through the defibrator 20 is conveyed through a conduit 3 to the separator 40. Note that the air stream for conveying the defibrated material from the defibrator 20 to the separator 40 may be the air current created by the defibrator 20, or a separate blower or other fan unit may be used to create the air current.

The separator 40 selects fibers by length from the defibrated material defibrated by the defibrator 20 that was introduced from the inlet 42. A sieve (sifter) is used as the separator 40. The separator 40 has mesh (filter, screen), and can separate fiber or particles that are smaller than the size of the openings in the mesh (that pass through the mesh, first selected material) from fiber, undefibrated shreds, and clumps that are larger than the openings in the mesh (that do not pass through the mesh, second selected material). For example, the first selected material is conveyed through a conduit 7 to the mixing device 50. The second selected material is returned from the outlet 44 through another conduit 8 to the defibrator 20. More specifically, the separator 40 is a cylindrical sieve that can be rotated by a motor. The mesh of the separator 40 may be a metal screen, expanded metal made by expanding a metal sheet with slits formed therein, or punched metal having holes formed by a press in a metal sheet.

The first web forming device 45 conveys the first selected material that has passed through the separator 40 to the mixing device 50. The first web forming device 45 includes, for example, a mesh belt 46, tension rollers 47, and a suction device (suction mechanism) 48.

The suction device 48 suctions the first selected material that has passed through the openings (mesh openings) in the separator 40 and was dispersed in air onto the mesh belt 46. The first selected material accumulates on the moving mesh belt 46, forming a web V. The basic configuration of the mesh belt 46, tension rollers 47, and suction device 48 are the same as the mesh belt 72, tension rollers 74, and suction mechanism 76 of the second web forming device 70 described below.

The web V is a soft, fluffy web containing a lot of air as a result of passing through the separator 40 and first web forming device 45. The web V formed on the mesh belt 46 is fed into a conduit 7 and conveyed to the mixing device 50.

The rotor 49 cuts the web V before the web V is conveyed to the mixing device 50. In the example in the figure, the rotor 49 has a base 49a, and blades 49b protruding from the base 49a. The blades 49b in this example have a flat shape. In the example in the figure, there are four blades 49b, and the four blades 49b are equally spaced around the base 49a. By the base 49a turning in direction R, the blades 49b rotate on the axis of the base 49a. By cutting the web V with the rotor 49, variation in the amount of defibrated material per unit time supplied to the air-laying device 60, for example, can be reduced.

The rotor 49 is disposed near the first web forming device 45. In the example in the figure, the rotor 49 is disposed near a tension roller 47a (beside the tension roller 47a) located at the downstream side of the conveyance path of the web V. The rotor 49 is disposed at a position where the blades 49b can contact the web V but do not touch the mesh belt 46 on which the web V is laid. As a result, wear (damage) to the mesh belt 46 by the blades 49b can be suppressed. The minimum distance between the blades 49b and mesh belt 46 is preferably greater than or equal to 0.05 mm and less than or equal to 0.5 mm. for example.

The mixing device 50 mixes an additive containing resin with the first selected material (the first selected material conveyed by the first web forming device 45) that has passed through the separator 40. The mixing device 50 has an additive supply device 52 that supplies additive, a conduit 54 for conveying the selected material and additive, and a blower 56. In the example in the figure, the additive is supplied from the additive supply device 52 through a hopper 9 to a conduit 54. Conduit 54 communicates with conduit 7.

The mixing device 50 uses the blower 56 to produce an air flow, and can convey while mixing the selected material and additives in the conduit 54. Note that the mechanism for mixing the first selected material and additive is not specifically limited, and may mix by means of blades turning at high speed, or may use rotation of the container like a V blender.

A screw feeder such as shown in FIG. 16, or a disc feeder not shown, for example, may be used as the additive supply device 52. The additive supplied from the additive supply device 52 contains resin for binding multiple fibers together. The multiple fibers are not bound at the time the resin is supplied. The resin melts and binds multiple fibers when passing through the sheet forming device 80.

The resin supplied from the additive supply device 52 is a thermoplastic resin or thermoset resin, such as AS resin, ABS resin, polypropylene, polyethylene, polyvinyl chloride, polystyrene, acrylic resin, polyester resin, polyethylene terephthalate, polyethylene ether, polyphenylene ether, polybutylene terephthalate, nylon, polyimide, polycarbonate, polyacetal, polyphenylene sulfide, and polyether ether ketone. These resins may be used individually or in a desirable combination. The additive supplied from the additive supply device 52 may be fibrous or powder.

Depending on the type of sheet being manufactured, the additive supplied from the additive supply device 52 may also include a coloring agent for coloring the fiber, an anti-blocking agent to prevent fiber agglomeration, or a flame retardant for making the fiber difficult to burn, in addition to resin for binding fibers. The mixture (a mixture of first selected material and additive) that passes through the mixing device 50 is conveyed through a conduit 54 to the air-laying device 60.

The mixture that has passed through the mixing device 50 is introduced to the air-laying device 60, which detangles and disperses the tangled defibrated material (fiber) in air while the mixture precipitates. When the resin in the additive supplied from the additive supply device 52 is fibrous, the air-laying device 60 also detangles interlocked resin fibers. As a result, the air-laying device 60 can lay the mixture uniformly in the second web forming device 70.

A cylindrical sieve that turns is used as the air-laying device 60. The air-laying device 60 has mesh, and causes fiber and particles smaller than the size of the mesh (that pass through the mesh) and contained in the mixture that has passed through the mixing device 50 to precipitate. The configuration of the air-laying device 60 is the same as the configuration of the separator 40 in this example.

Note that the sieve of the air-laying device 60 may be configured without functionality for selecting specific material. More specifically, the “sieve” used as the air-laying device 60 means a device having mesh, and the air-laying device 60 may cause all of the mixture introduced to the air-laying device 60 to precipitate.

The second web forming device 70 lays the precipitate that has passed through the air-laying device 60 into a web W. The web forming device 70 includes, for example, a mesh belt 72, tension rollers 74, and a suction mechanism 76.

The mesh belt 72 is moving while precipitate that has passed through the holes (mesh) of the air-laying device 60 accumulates thereon. The mesh belt 72 is tensioned by the tension rollers 74, and is configured so that air passes through but it is difficult for the precipitate to pass through. The mesh belt 72 moves when the tension rollers 74 turn. A web W is formed on the mesh belt 72 as a result of the mixture that has passed through the air-laying device 60 precipitating continuously while the mesh belt 72 moves continuously. The mesh belt 72 may be metal, plastic, cloth, or nonwoven cloth.

The suction mechanism 76 is disposed below the mesh belt 72 (on the opposite side as the air-laying device 60). The suction mechanism 76 can produce a downward flow of air (air flow directed from the air-laying device 60 to the mesh belt 72). The mixture distributed in air by the air-laying device 60 can be pulled onto the mesh belt 72 by the suction mechanism 76. As a result, the discharge rate from the air-laying device 60 can be increased. A downward air flow can also be created in the descent path of the mixture, and interlocking of defibrated material and additive during descent can be prevented, by the suction mechanism 76.

A soft, fluffy web W containing much air is formed by material passing through the air-laying device 60 and second web forming device 70 (web forming process) as described above. The web W laid on the mesh belt 72 is then conveyed to the sheet forming device 80.

Note that a moisture content adjustment device 78 for adjusting the moisture content of the web W is disposed in the example shown in the figure. The moisture content adjustment device 78 adds water or water vapor to the web W to adjust the ratio of water to the web W.

The sheet forming device 80 applies heat and pressure to the web W laid on the mesh belt 72, forming a sheet S. By applying heat to the mixture of defibrated material and additive contained in the web W, the sheet forming device 80 can bind fibers in the mixture together through the additive (resin).

The sheet forming device 80 includes a compression device 82 that compresses the web W, and a heater 84 that heats the web W after being compressed by the compression device 82. The compression device 82 in this example comprises a pair of calender rolls 85 that apply pressure to the web W. Calendering reduces the thickness of the web W and increases the density of the web W. A heat roller (heating roller), hot press molding machine, hot plate, hot air blower, infrared heater, or flash fuser, for example, may be used as the heater 84. In the example in the figure, the heater 84 comprises a pair of heat rollers 86. By configuring the heater 84 with heat rollers 86, a sheet S can be formed while continuously conveying the web W, unlike when the heater 84 is configured with a flat press (flat press machine). The calender rolls 85 (compression device 82) can apply greater pressure to the web W than the pressure that can be applied by the heat rollers 86 (heater 84). Note that the number of calender rolls 85 and heat rollers 86 is not specifically limited.

The cutting device 90 cuts the sheet S formed by the sheet forming device 80. In the example in the figure, the cutting device 90 has a first cutter 92 that cuts the sheet S crosswise to the conveyance direction of the sheet S, and a second cutter 94 that cuts the sheet S parallel to the conveyance direction. In this example, the second cutter 94 cuts the sheet S after passing through the first cutter 92.

Cut sheets S of a specific size are formed by the process described above. The cut sheets S are then discharged to the stacker 96.

Effects of this embodiment are described below.

Sheets Pu that are determined to not be reusable can be shredded, and the shreds of the shredded sheets Pu can be used as feedstock to produce new sheets S.

The present invention is not limited to the foregoing embodiment, and the foregoing embodiment can be modified and improved in many ways. Examples of some variations are described below. These examples may also be used in combination.

### Variation 1

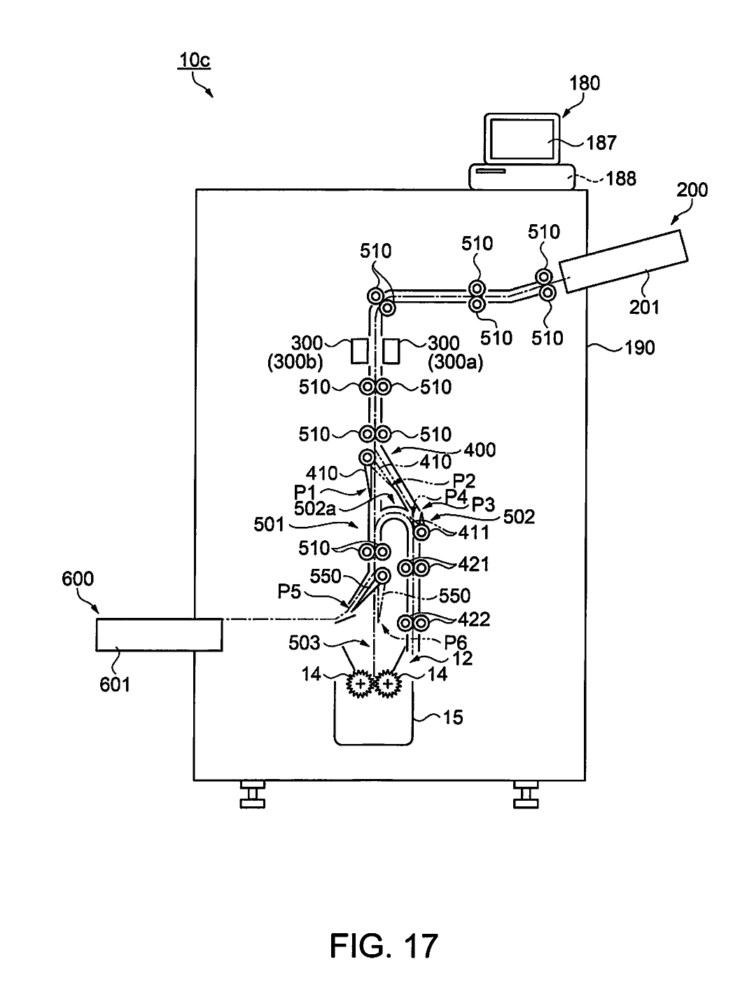

The sheet processing device 10 according to the first embodiment described above is configured with both the supply device 200 and the sheet stacker 600 disposed inside the case 190, but the invention is not limited to this configuration. For example, a configuration in which either the supply device 200 or the sheet stacker 600 is disposed outside the case 190 is also conceivable. FIG. 17 schematically illustrates the configuration of a sheet processing device according to a first variation. As shown in FIG. 17, this sheet processing device 10c includes a supply device 200, an image acquisition device 300, an inverter 400, a shredder 12, and a sheet stacker 600. The image acquisition device 300, inverter 400, and shredder 12 are disposed inside the case 190, but the supply device 200 and sheet stacker 600 are located outside the case 190. Note that the parts configuration of the sheet processing device 10c shown in FIG. 17 is the same as the configuration of the first embodiment, and further description thereof is omitted. This configuration enables loading and removing sheets Pu without opening the case 190, and operation is therefore easier.

### Variation 2

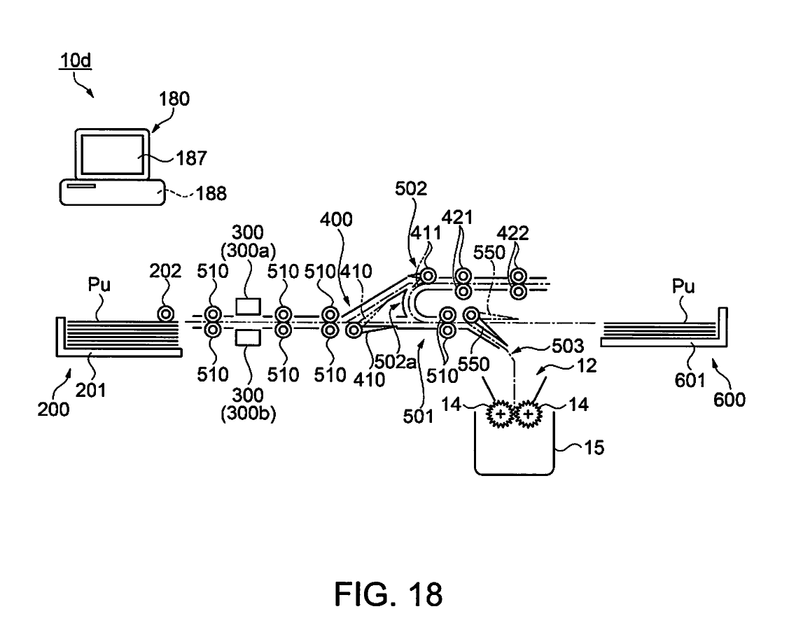

The sheet processing device 10 according to the first embodiment of the invention is configured with the relationship between the supply device 200 and sheet stacker 600 oriented in the direction of gravity (vertically), that is, in a vertical configuration, but the invention is not limited to this configuration. For example, a configuration in which the supply device 200 and sheet stacker 600 are in a horizontal relationship (left-right direction), that is, a horizontal configuration, is also conceivable. FIG. 18 schematically illustrates the configuration of a sheet processing device according to a second variation of the invention. As shown in FIG. 18, the sheet processing device 10d has a supply device 200, an image acquisition device 300, an inverter 400, a shredder 12, and a sheet stacker 600. The sheet manufacturing apparatus 200 and sheet stacker 600 are disposed in opposition in a substantially horizontal direction. Note that the parts configuration of the sheet processing device 10d shown in FIG. 18 is the same as the configuration of the first embodiment, and further description thereof is omitted. This configuration also achieves the effects described above.

### Variation 3

The first embodiment has a first image acquisition device 300a that acquires an image of the first side of the sheet Pu, and a second image acquisition device 300b that acquires an image of the second side of the sheet Pu, but the invention is not limited to this configuration. For example, a configuration that disposes an image acquisition device 300 on only one of the first side and second side of the sheet Pu is also conceivable. More specifically, the number of image acquisition devices 300 is not limited as long as reusability of sheets Pu can be determined based on the recorded state of images on the other side of the sheet Pu in addition to images on one side of a sheet Pu. In this case, the number of image acquisition devices 300 can be reduced compared with providing an image acquisition device 300 (300a, 300b) for each side of the sheet Pu.

### Variation 4

In the first embodiment described above, sheets Pu that can be reused are discharged and stored in one sheet stacker 600, but the invention is not limited to this configuration. For example, a configuration that sorts the sheets Pu by paper size, has a sheet stacker 600 may be provided for each size of paper, and based on the image data Pu′ acquired by the image acquisition device 300 stores to the sheet stacker 600 corresponding to the paper size (such as A4 size or A3 size) of the sheet Pu is also conceivable. This configuration makes handling sheets Pu that can be reused even easier.

### Variation 5

In the sheet processing device 10a according to the second embodiment of the invention the eraser device 700 is a heat roller pair, but the invention is not limited to this configuration. For example, the eraser device 700 may be a far infrared heater. This configuration can also erase (decolorize) images recorded in erasable ink by the heat of the far infrared heater. Furthermore, because the sheet Pu can be heated contactlessly, damage to the sheet Pu can be prevented.

### Variation 6

In the sheet processing device 10a according to the second embodiment of the invention, a configuration using an erasable toner or erasable ink (such as a leuco dye ink) that can be decolorized by applying heat is described, but the invention is not so limited. For example, an ultraviolet erasable ink that uses a UV-sensitive photochromic compound with the ability to be erased (decolorized) by exposure to ultraviolet light is also conceivable. In this case, a UV emission device capable of emitting UV light may be used as the eraser device 700. More specifically, an eraser device 700 (UV emission device) that emits UV light to the sheet Pu is disposed between the supply device 200 and image acquisition device 300. This configuration enables erasing (decolorizing) images recorded with UV erasable ink.

In another example, a near infrared erasable ink that uses a near infrared-sensitive photochromic compound with the ability to be erased (decolorized) by exposure to near infrared light is also conceivable. In this case, a UV emission device capable of emitting near infrared light may be used as the eraser device 700. More specifically, an eraser device 700 (near infrared emission device) that emits near infrared light to the sheet Pu is disposed between the supply device 200 and image acquisition device 300. This configuration enables erasing (decolorizing) images recorded with near infrared erasable ink.

### Variation 7

In the sheet processing device 10b according to the third embodiment of the invention, whether or not a recorded image is on the sheet Pu is determined, and if the sheet Pu is determined to not be reusable, the sheet Pu is shredded by the shredder 12, but the invention is not limited to this configuration. For example, whether or not there is a problem with the surface condition of the sheet Pu may be determined, and if the sheet Pu is determined to not be reusable, the sheet Pu may be shredded by the shredder 12. This configuration can reliably remove sheets Pu that are not suitable for reuse.

### Variation 8

The sheet processing device 10b according to the third embodiment of the invention is configured to produce sheets Pu using a dry paper-making method to form the sheets S, but the invention is not so limited. For example, sheets Pu may by processed by a wet paper-making method to make new sheets S. This configuration has the same effect as described above.

[Reference Signs List]

| 10, 10a, 10b, 10d, | sheet processing device |
|---|---|
| 12 | shredder |
| 80 | sheet forming device |
| 180 | controller (first decision device, second decision |
| | device) |
| 187 | touch panel |
| 188 | network communicator |
| 190 | case |
| 200 | supply device |
| 300 | image acquisition device |
| 300a | first image acquisition device |
| 300b | second image acquisition device |
| 400 | inverter |
| 410 | first diverter |
| 411 | second diverter |
| 421, 422 | inverter roller pair |
| 501 | first conveyance path |
| 502 | second conveyance path |
| 502a | sheet-inverting conveyance path |
| 503 | third conveyance path |
| 510 | conveyance roller pair |
| 550 | third diverter |
| 600 | sheet stacker |
| 700 | eraser device |

1. A sheet processing device comprising:
a supply device that supplies a sheet;
an image acquisition device that acquires an image of a sheet supplied from the supply device;
a first decision device that determines whether or not the sheet can be reused based on the image of the sheet acquired by the image acquisition device; and
an inverter configured to discharge the sheet without reversing the first side and second side of the sheet when the first decision device determines that the first side of the sheet can be reused, and reverses the first side and second side of the sheet and then discharges the sheet when the first decision device determines that the second side of the sheet can be reused.

2. The sheet processing device described in claim 1, further comprising:
a shredder configured to shred sheets;
the shredder shredding the sheet when the first decision device determines both the first side and second side of the sheet cannot be reused.

3. The sheet processing device described in claim 2, further comprising:
a defibrator configured to defibrate into defibrated material shreds shredded by the shredder; and
a sheet forming device configured to form sheets using at least part of the defibrated material.

4. The sheet processing device according to claim 2, wherein:
the first decision device has a second decision device that determines whether or not there is a problem with the surface condition of the sheet based on an image of the sheet acquired by the image acquisition device; and
the shredder shreds the sheet when the second decision device determines there is a problem with the surface condition of the sheet.

5. The sheet processing device according to claim 1, further comprising:
an eraser device disposed between the supply device and the image acquisition device in the conveyance direction of the sheet, and configured to erase an image recorded on the sheet.

6. A sheet processing method comprising:
supplying a sheet;
acquiring an image of a supplied sheet;
determining whether or not the sheet can be reused based on the acquired image of the sheet; and
discharging the sheet without reversing the first side and second side of the sheet when the first side of the sheet is determined to be reusable, and reversing the first side and second side of the sheet and then discharging the sheet when the second side of the sheet is determined to be reusable.
